(19) United States
(12) Patent Application Publication
(10) Pub. No.: US 2026/0358883 A1
(43) Pub. Date: Nov. 12, 2026

(54) DEVICE CONTROL METHOD, ELECTRONIC DEVICE, AND STORAGE MEDIUM

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YU-ZHONG FENG, Shenzhen (CN)

(21) Appl. No.: 19/672,963

(22) Filed: May 11, 2026

(30) Foreign Application Priority Data
May 12, 2025 (CN) 202510605201.2

(51) Int. Cl. G06F 3/01

(52) U.S. Cl. CPC G06F 3/011

(57) ABSTRACT

The present application provides a device control method, an electronic device, and a storage medium. In the method, in response to a first operation by a user, a first posture of the electronic device and a second posture of the wearable device are determined. Under the condition that the second posture does not match the first posture, a second operation is determined based on the first posture and the second posture, and a control instruction is sent to the wearable device. The wearable device controls display information by executing the second operation. By utilizing the method, the device control efficiency of the wearable device can be improved.

### FIELD

The present application belongs to an intelligent control technology field, particularly relates to a device control method, an electronic device, and a storage medium.

### BACKGROUND

With the rapid development of information technology, smart wearable devices, especially smart glasses, serve as a bridge connecting the real world and the digital world, rapidly chang our lifestyle.

However, most smart wearable devices have limited interactive functions, resulting in ineffective device control.

### BRIEF DESCRIPTION OF THE DRAWINGS

To more clearly illustrate the technical solutions in the embodiments of the present application, the drawings required for describing the embodiments are briefly introduced below. Apparently, the drawings in the following description are only some embodiments of the present application. For those of ordinary skill in the art, other drawings can be obtained based on these drawings without creative effort.

FIG. 1 is an application scenario diagram of the device control method in an embodiment of the present application.

FIG. 2 is a flow chart of a device control method provided by an embodiment of the present application.

FIG. 3 is a flow chart of an operation conversion method provided by an embodiment of the present application.

FIG. 4 is an interaction scenario diagram provided by a first embodiment of the present application.

FIG. 5 is an interaction scenario diagram provided by a second embodiment of the present application.

FIG. 6 is a schematic diagram of a first tilt angle provided by an embodiment of the present application.

FIG. 7 is a schematic diagram of a second tilt angle provided by an embodiment of the present application.

FIG. 8 is a schematic structural diagram of a device control apparatus provided by an embodiment of the present application.

FIG. 9 is a schematic structural diagram of an electronic device provided by an embodiment of the present application.

### DETAILED DESCRIPTION

The technical solutions in the embodiments of the present application will be clearly and completely described below in conjunction with the accompanying drawings in the embodiments of the present application. Apparently, the described embodiments are only some, not all, of the embodiments of the present application. Based on the embodiments in the present application, all other embodiments obtained by those of ordinary skill in the art without creative effort fall within the protection scope of the present application.

Hereinafter, the terms “first,” “second,” etc., are used for descriptive purposes only and are not to be construed as indicating or implying relative importance or implicitly indicating the number of technical features indicated. Thus, features defined with “first,” “second” may explicitly or implicitly include one or more of such features. In the description of the embodiments of the present application, words such as “exemplary” or “for example” are used to indicate examples, illustrations, or explanations. Any embodiment or design described as “exemplary” or “for example” in the embodiments of the present application should not be construed as being more preferred or advantageous than other embodiments or designs. Rather, the use of words such as “exemplary” or “for example” is intended to present related concepts in a specific manner.

Unless otherwise defined, all technical and scientific terms used herein have the same meaning as commonly understood by one of ordinary skill in the art to which this application belongs. The terminology used in the specification of this application is for the purpose of describing particular embodiments only and is not intended to limit this application. It should be understood that, unless otherwise stated in this application, “at least one” means one or more. “Plurality” means two or more than two. For example, at least one of a, b, or c may represent: a, b, c, a and b, a and c, b and c, a, b, and c, seven cases.

With the rapid development of technology, wearable devices are gradually integrating into people's daily lives and work. Wearable devices integrate multiple functions, such as information display, communication, navigation, photography and videography, and health determining, providing users with a more convenient and rich interactive experience.

However, most wearable devices have limited interaction functions, resulting in poor device control effectiveness. For example, users perform various operations on the wearable device through voice commands. However, due to environmental noise, the accuracy of voice recognition by the wearable device is low, resulting in poor device control effectiveness. For another example, some wearable devices are equipped with a touchpad or touchscreen, allowing users to implement various functions through touch operations. However, since the touch area of the wearable device is relatively limited, when a precise operation is required, inadvertent touches result in wrong operations.

In view of the above issues, a device control method, an electronic device and a storage medium are provided in some embodiments to improve device control effectiveness of the wearable devices.

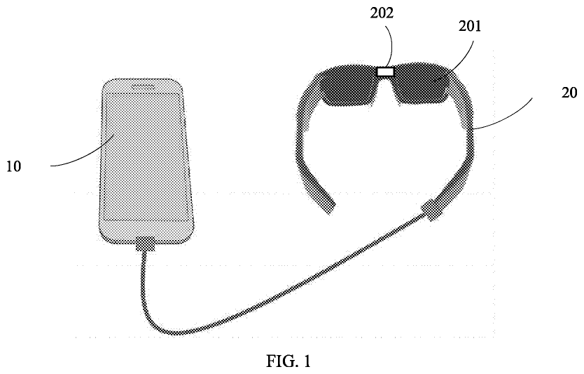

FIG. 1 is an application scenario diagram of the device control method provided by an embodiment of the present application. As shown in FIG. 1, an electronic device 10 is communicatively connected to a wearable device 20. A number of electronic devices 10 and wearable devices 20 can be set according to actual requirements and is not limited herein. The electronic device 10 can provide multimedia content for the wearable device 20, and the multimedia content may include videos, documents, pictures, games, for example. The communication connection may include a wired connection via a data cable for example, and a wireless connection, such as Wi-Fi, Bluetooth, a cellular network, a near-field communication, for example. In some embodiment of the present application, the wired connection is used as an example for description. Through the wired connection, the electronic device 10 may provide power supply and transmit data to the wearable device 20.

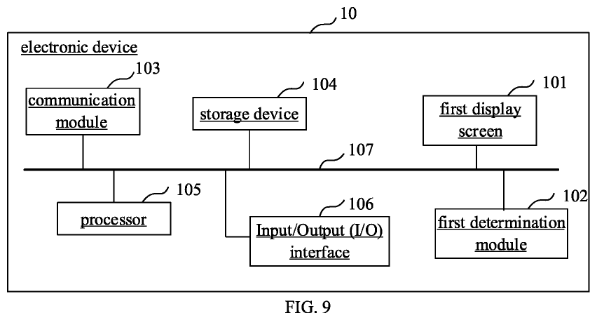

In some embodiments, the electronic device 10 may include electronic products with data processing and interaction capabilities, such as a personal computer, a tablet computer, a smartphone, a digital camera, for example. The electronic device 10 may include a first display screen 101 (shown in FIG. 9) and a first determination module 102 (shown in FIG. 9). The first display screen 101 can display multimedia content and record user operation information (referred to as “first operation” for ease of description). The first determination module 102 can determine the posture of the electronic device 10 (referred to as “first posture” for ease of description). The first determination module 102 may include a gyroscope, a gravity sensor, etc., which are not limited herein.

The first posture may include a landscape posture, a portrait posture (referred to the posture of the electronic device 10 in FIG. 1), and a tilted posture. The terminal device determines an axis parallel to a horizontal line as an X-axis, and determines an axis perpendicular to the horizontal line as a Y-axis, determines an axis perpendicular to the X-axis and parallel to the horizontal line as a Z-axis, determines a geometric center of the electronic device 10 as a coordinate origin. The terminal device construct a coordinate system based on the X-axis, the Y-axis, and the Z-axis. In response to a determination that an angle between a line of the long side of the first display screen 101 of the electronic device 10 and the X-axis direction (referred to as “first axial direction” for ease of description) is less than or equal to a preset angle value, the electronic device 10 is determined to be in the landscape posture. In response to a determination that the angle between the line of a short side of the first display screen 101 of the electronic device 10 and the first axial direction is less than or equal to a preset angle value, the electronic device 10 is determined to be in the portrait posture. If the electronic device 10 is neither in the landscape posture nor the portrait posture, it is determined to be in a tilted posture. The preset angle value can be set according to actual requirements, for example, the preset angle value can be 1 degree, 5 degrees, 6 degrees, etc.

In some embodiments, the first determination module 102 can determine the first posture of the electronic device 10 by detecting the first angular velocity and/or first acceleration of the electronic device 10 in preset axial directions. The preset axial directions may include the X-axis direction (e.g., the first axial direction), the Y-axis direction (also referred to as the “second axial direction” for ease of description), and the Z-axis direction in a three-dimensional Cartesian coordinate system. In response to a determination that the electronic device 10 is in a stationary state, the first posture of the electronic device 10 can be determined by determining the first acceleration of the electronic device 10 in the preset axial directions. In response to a determination that electronic device 10 is in a moving state, the first posture of the electronic device 10 is determined by determining the first acceleration and first angular velocity of the electronic device 10 in the preset axial directions. For example, the first determination module 102 uses a gravity sensor to determine the first acceleration of the electronic device 10 in the X-axis direction, the first acceleration of the electronic device 10 in the Y-axis direction, and the first acceleration of the electronic device 10 in the Z-axis direction, and the first determination module 102 uses a gyroscope to determine the first angular velocity of the electronic device 10 in the X-axis direction, the first angular velocity of the electronic device 10 in the Y-axis direction, and the first angular velocity of the electronic device 10 in the Z-axis direction. In response to a determination that the electronic device 10 is in a stationary state, and the first acceleration of the electronic device 10 in the X-axis direction is greater than the first acceleration in the Y-axis direction, it is determined that the electronic device 10 is in the landscape posture. In response to a determination that the first acceleration of the electronic device 10 in the X-axis direction is less than the first acceleration in the Y-axis direction, it is determined that the electronic device 10 is in the portrait posture. In response to a determination that the electronic device 10 is in a moving state, the first acceleration of the electronic device 10 in the X-axis direction, the first acceleration of the electronic device 10 in the Y-axis direction, and the first acceleration of the electronic device 10 in the Z-axis direction are determined, and the direction angle of the gravity vector is determined based on the first acceleration in the X-axis direction, the first acceleration in the Y-axis direction, and the first acceleration in the Z-axis direction. Also, the first angular velocity of the electronic device 10 in the X-axis direction, the first angular velocity of the electronic device 10 in the Y-axis direction, and the first angular velocity of the electronic device 10 in the Z-axis direction are determined, and the dynamic rotation angle of the electronic device 10 is determined using the first angular velocity of the electronic device 10 in the X-axis direction, the first angular velocity of the electronic device 10 in the Y-axis direction, and the first angular velocity of the electronic device 10 in the Z-axis direction. The first posture of the electronic device 10 can be determined based on the direction angle of the gravity vector and the dynamic rotation angle. For example, a sum of the direction angle of the gravity vector and the dynamic rotation angle is determined, and the sum is used as a corrected device posture angle. In response to a determination that an angular difference between the corrected device posture angle and 0 degrees is less than or equal to a preset angle value, or an angular difference between the corrected device posture angle and 180 degrees is less than or equal to a preset angle value, it is determined that the electronic device 10 is in the portrait posture; in response to a determination that an angular difference between the corrected device posture angle and 90 degrees is less than or equal to a preset angle value, or an angular difference between the corrected device posture angle and 270 degrees is less than or equal to the preset angle value, it is determined that the electronic device 10 is in the landscape posture. For example, under the condition that an angular difference between the corrected device posture angle and 0 degree is less than or equal to a preset angle value, the corrected device posture angle is determined to be close 0 degree. The preset angle value can be set according to actual requirements, for example, the preset angle value can be 1 degree, 5 degrees, 6 degrees, etc. In some embodiments, the direction angle of the gravity vector can be determined using an arctangent function based on the first acceleration of the electronic device 10 in the X-axis direction and the first acceleration in the Y-axis direction. In some embodiments, the first angular velocity that has the greatest impact on determining the first posture of the electronic device 10 can be selected as the dynamic rotation angle of the electronic device 10. For example, the first angular velocity of the electronic device 10 in the Z-axis direction can be used as the dynamic rotation angle of the electronic device 10.

In some embodiments, the wearable device 20 may include smart glasses, a smart watch/band, a virtual reality headset, an augmented reality headset, a smart ring, smart clothing. In the following descriptions, smart glasses are provided as an example of the wearable device 20to describe embodiments of the present application. The wearable device 20 includes a second display screen 201 and a second determination module 202. The second display screen 201 has a display function for displaying multimedia content. The number of second display screens 201 can be set according to actual requirements, for example, the number of second display screens 201 can be 1, 2, or more. For example, referring to FIG. 1, the second display screens 201 can be two lenses of the wearable device 20. The second determination module 202 is used to determine the posture of the wearable device 20 (referred to as “second posture” for ease of description). The second determination module 202 may include a gyroscope, a gravity sensor, etc., which are not limited herein.

The second posture may include a landscape posture (referred to the posture of the wearable device in FIG. 1), a portrait posture, and a tilted posture. Determining a line based of the position of two lenses, in response to a determination that the angle between the line and the X-axis direction is less than or equal to a preset angle value, the wearable device 20 is determined to be in the landscape posture; in response to a determination that the angle between the line where the two lenses of the wearable device 20 lie and the Y-axis direction is less than or equal to a preset angle value, the wearable device 20 is determined to be in the portrait posture; in response to a determination that the wearable device 20 is neither in the landscape posture nor the portrait posture, it is determined to be in a tilted posture.

In some embodiments, the second determination module 202 can determine the second posture of the wearable device 20 by determining the second acceleration and/or second angular velocity of the wearable device 20 in preset axial directions. If the wearable device 20 is in a stationary state, the second posture of the wearable device 20 can be determined by determining the second acceleration of the wearable device 20 in the preset axial directions. If the wearable device 20 is in a moving state, the second posture of the wearable device 20 is determined by determining the second acceleration and second angular velocity of the wearable device 20 in the preset axial directions. Exemplarily, the second determination module 202 uses a gravity sensor to determine the second acceleration of the wearable device 20 in the X-axis direction, Y-axis direction, and Z-axis direction, and the second determination module 202 uses a gyroscope to determine the second angular velocity of the wearable device 20 in the X-axis direction, Y-axis direction, and Z-axis direction. If the wearable device 20 is stationary, and the second acceleration of the wearable device 20 in the X-axis direction is greater than the second acceleration in the Y-axis direction and the Z-axis direction, it is determined that the wearable device 20 is in the landscape posture; if the second acceleration of the wearable device 20 in the Y-axis direction is greater than the second acceleration in the X-axis direction and the Z-axis direction, it is determined that the wearable device 20 is in the portrait posture. If the wearable device 20 is in motion, the second acceleration of the wearable device 20 in the X-axis direction, Y-axis direction, and Z-axis direction are respectively determined, and the direction angle of the gravity vector is determined based on the second acceleration in the X-axis direction, Y-axis direction, and Z-axis direction. Also, the second angular velocity of the wearable device 20 in the X-axis direction, Y-axis direction, and Z-axis direction are respectively determined, and the dynamic rotation angle of the wearable device 20 is determined using the second angular velocity of the wearable device 20 in the X-axis direction, Y-axis direction, and Z-axis direction. The second posture of the wearable device 20 can be determined based on the direction angle of the gravity vector and the dynamic rotation angle. For example, the sum of the direction angle of the gravity vector and the dynamic rotation angle is determined, and the sum is used as a corrected device posture angle. If the corrected device posture angle is close to 0 degrees or 180 degrees, it is determined that the wearable device 20 is in the portrait posture; if the corrected device posture angle is close to 90 degrees or 270 degrees, it is determined that the wearable device 20 is in the landscape posture. Here, “close” indicates that the angular difference between the two is less than or equal to a preset angle value. For example, the corrected device posture angle being close to 0 degrees may indicate that the angular difference between the corrected device posture angle and 0 degrees is less than or equal to a preset angle value. The preset angle value can be set according to actual requirements, for example, the preset angle value can be 1 degree, 5 degrees, 6 degrees, etc. In some embodiments, the direction angle of the gravity vector can be determined using an arctangent function based on the second acceleration of the wearable device 20 in the X-axis direction and the second acceleration in the Y-axis direction. In some embodiments, the second angular velocity that has the greatest impact on determining the second posture of the wearable device 20 can be selected as the dynamic rotation angle of the wearable device 20. For example, the second angular velocity of the wearable device 20 in the Z-axis direction can be used as the dynamic rotation angle of the wearable device 20.

In some embodiments, in response to a user's first operation on the first display screen 101 of the electronic device 10, the electronic device 10 may send a control instruction to the wearable device 20. The wearable device 20 controls display information by executing the control instruction. In other embodiments, in response to the user's first operation on the first display screen 101 of the electronic device 10, the electronic device 10 adjusts the first operation based on the first posture and the second posture to trigger a second operation, and sends a control instruction to the wearable device 20, the wearable device 20 controls display information by executing the control instruction.

In some embodiments, the electronic device 10 is communicatively connected to the wearable device 20, and the electronic device 10 provides the displayed multimedia content to the wearable device 20. In response to the user's first operation on the first display screen 101 of the electronic device 10, the electronic device 10 can control the information displayed on the second display screen 201 of the wearable device 20, thus, the wearable device 20 can be controlled efficiently. Moreover, the electronic device 10 sends the control instruction to the wearable device 20 based on the first posture and the second posture, avoiding the influence of posture changes of the electronic device 10 and the wearable device 20 on device control, and the device control accuracy of the wearable device 20 can be improved.

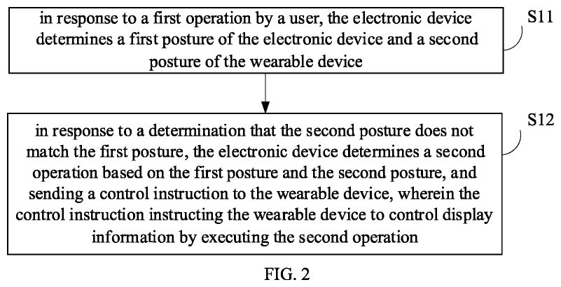

FIG. 2 is a flowchart of a device control method provided by an embodiment of the present application. The device control method is applied to an electronic device (e.g., electronic device 10 in FIG. 1). As shown in FIG. 2, the device control method includes the following steps. Depending on different requirements, the order of the steps in this flowchart may be changed, and some steps may be omitted.

S11, in response to a first operation by a user, the electronic device determines a first posture of the electronic device and a second posture of the wearable device.

In some embodiments, the user may activate the first display screen of the electronic device by performing relevant operations on physical buttons or functional controls (e.g., icons, widgets, for example) on a touch area of the electronic device, execute the first operation on the first display screen to control the display information of the wearable device by using the electronic device. The first operation may represent a touch operation performed by the user on the first display screen of the electronic device. The first operation may include a sliding operation, a two-finger zoom-in/out operation, a tap/double-tap operation, a multi-finger drag operation, etc.

In some embodiments, the first posture is used to describe posture information of the electronic device. The first posture may include a landscape posture, a portrait posture, and a tilted posture. In response to a determination that the angle between the line where the long side of the first display screen of the electronic device lies and the first axial direction is less than or equal to a preset angle value, the electronic device is determined to be in the landscape posture. For example, in a gaming scenario, when the user is playing games, the electronic device is mostly in the landscape posture. If the angle between the line where the short side of the first display screen of the electronic device lies and the first axial direction is less than or equal to a preset angle value, the electronic device is determined to be in the portrait posture. For example, in a social chat scenario, when the user sends instant messages or video chats with others, the electronic device is mostly in the portrait posture. The tilted posture indicates that the electronic device is placed tilted, e.g., the electronic device is neither in the landscape posture nor the portrait posture.

In some embodiments, the second posture represents posture information of the wearable device. The second posture may include a landscape posture, a portrait posture, and a tilted posture. In response to a determination that the angle between the line of the two lenses of the wearable device and the first axial direction is less than or equal to a preset angle value, the wearable device is determined to be in the landscape posture. For example, in a scenario where the user is sitting, the wearable device is mostly in the landscape posture. In response to a determination that the angle between the line where the two lenses of the wearable device lie and the second axial direction is less than or equal to a preset angle value, the wearable device is determined to be in the portrait posture. For example, in a scenario where the user is lying on their side, the wearable device is mostly in the portrait posture. The tilted posture describes the wearable device being placed at an incline, e.g., the wearable device is neither in the landscape posture nor the portrait posture.

In some embodiments, for example the use of a gravity sensor and a gyroscope, the terminal device determines the first posture of the electronic device and the second posture of the wearable device includes: determining a first angular velocity and/or a first acceleration of the electronic device in a plurality of preset axial directions; determining the first posture of the electronic device based on the first angular velocity and/or the first acceleration; and determining a second angular velocity and/or a second acceleration of the wearable device in the plurality of preset axial directions; determining the second posture of the wearable device based on the second angular velocity and/or the second acceleration.

In response to a determination that the electronic device is in a stationary state, the first posture of the electronic device is determined based on the first acceleration of the electronic device in the X-axis direction, the first acceleration of the electronic device in the Y-axis direction, and the first acceleration of the electronic device in the Z-axis direction; in response to a determination that the electronic device is in a moving state, the first posture of the electronic device is determined based on the first acceleration and first angular velocity of the electronic device in the X-axis direction, Y-axis direction, and Z-axis direction. The method for determining the first posture has been described in detail above and will not be repeated here.

In response to a determination that the wearable device is in a stationary state, the second posture of the wearable device is determined based on the second acceleration of the wearable device in the X-axis direction, the second acceleration of the wearable device in the Y-axis direction, and the second acceleration of the wearable device in the Z-axis direction; in response to a determination that the wearable device is in a moving state, the second posture of the wearable device is determined based on the second acceleration and second angular velocity of the wearable device in the X-axis direction, the second acceleration and second angular velocity of the wearable device in the Y-axis direction, and the second acceleration and second angular velocity of the wearable device in the Z-axis direction. The method for determining the second posture has been described in detail above and will not be repeated here.

In some embodiments, the first angular velocity and/or the first acceleration of the electronic device are used in multiple preset axial directions. When the electronic device is in a moving state, the first angular velocity acquired from the gyroscope is used to dynamically compensate for the first acceleration from the gravity sensor, thereby reducing judgment errors in the moving state and improving the accuracy of determining the first posture of the electronic device. Similarly, using the second angular velocity and/or second acceleration of the wearable device in multiple preset axial directions, when the wearable device is in a moving state, the second angular velocity acquired from the gyroscope is used to dynamically compensate for the second acceleration from the gravity sensor, reduce judgment errors in the moving state and improve the accuracy of determining the second posture of the wearable device, thereby improving the accuracy and speed of device control.
S12, in response to a determination that the second posture does not match the first posture, the electronic device determines a second operation based on the first posture and the second posture, and sending a control instruction to the wearable device, wherein the control instruction instructing the wearable device to control display information by executing the second operation.

In at least one embodiment of the present application, a first preset posture and a second preset posture can be pre-set. Based on the first posture and the first preset posture, and the second posture and the second preset posture, it can be determined whether the second posture matches the first posture. The first preset posture and the second preset posture may be the same or different, and are not limited herein. In some embodiments, for example the first preset posture and the second preset posture being the same, and both being the landscape posture. In some embodiments, in response to a determination that the first posture is a portrait posture and the second posture is the portrait posture, or in response to a determination that the first posture is a landscape posture and the second posture is the landscape posture, it is determined that the second posture matches the first posture. If the first posture is a portrait posture and the second posture is a landscape posture, or if the first posture is the landscape posture and the second posture is the portrait posture, it is determined that the second posture does not match the first posture. If the first posture is a first tilted posture and the second posture is a second tilted posture, it is determined that the second posture does not match the first posture.

In some embodiments, if the second posture matches the first posture, it is indicated that the user's first operation on the electronic device can be sent to the wearable device without adjusting the first operation. For example, in response to a determination that the first posture is a portrait posture and the second posture is the portrait posture, or the first posture is a landscape posture and the second posture is the landscape posture, the terminal device send the control instruction to the wearable device, so that the wearable device controls the display information by executing the first operation. The control instruction is used to instruct controlling the display information of the wearable device based on the first operation.

In some embodiments, if the second posture does not match the first posture, it indicates that the first operation needs to be converted so that the first operation conforms to the display interface posture of the wearable device. Taking the case where the first posture is a portrait posture and the second posture is a landscape posture, or the first posture is the landscape posture and the second posture is the portrait posture, or the first posture is a first tilted posture and the second posture is a second tilted posture as an example: determining a second operation based on the first posture and the second posture, and sending a control instruction to the wearable device, so that the wearable device controls display information by executing the second operation.

In the device control method provided by the embodiments of the present application, by identifying the first posture of the electronic device and the second posture of the wearable device, the first operation on the electronic device is converted using the first posture and the second posture to obtain a second operation, so that the wearable device controls display information by executing the second operation, thereby avoiding the influence of posture changes of the electronic device and the wearable device on device control, and improving the device control accuracy of the wearable device. Moreover, by operating on the electronic device to control the wearable device, the present application makes the wearable device easy to control, thereby improving the device control efficiency of the wearable device.

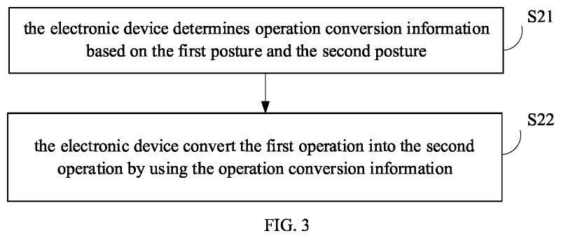

In at least one embodiment of the present application, if the second posture does not match the first posture, the first operation needs to be converted to obtain a second operation, so that the wearable device controls display information by executing the second operation. FIG. 3 is a schematic flowchart of an operation conversion method provided by an embodiment of the present application. The first operation conversion method is applied to an electronic device. As shown in FIG. 3, it includes the following steps.
S21, the electronic device determines operation conversion information based on the first posture and the second posture.

In at least one embodiment, the second posture of the wearable device does not match the first posture of the electronic device may include the first posture is a portrait posture and the second posture is a landscape posture, or the first posture is a landscape posture and the second posture is a portrait posture, or the first posture is a first tilted posture and the second posture is a second tilted posture. The operation conversion information indicates adjustments to the operation values of the first operation in various axial directions.

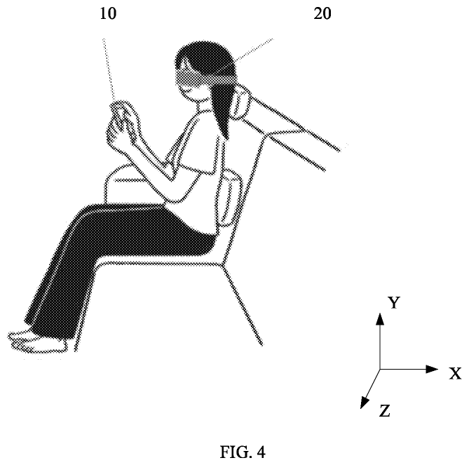

In some embodiments, for example the first posture is a portrait posture and the second posture is a landscape posture, or the first posture is a landscape posture and the second posture is a portrait posture, as shown in FIG. 4, a user wears the wearable device 20 and operates the electronic device 10 while sitting on a chair. At this time, the electronic device 10 is in the portrait posture, and the wearable device 20 is in the landscape posture. In some embodiments, the terminal device determines the operation conversion information based on the first posture and the second posture includes the terminal device determines a first operation value of the first operation in a first axial direction and a second operation value of the first operation in a second axial direction; determining the operation conversion information by changing the first operation value of the first operation in a first axial direction to the second operation value of the first operation in a first axial direction. Since the first preset posture and the second preset posture are the landscape posture, when the first posture is the portrait posture and the second posture is the landscape posture, or the first posture is the landscape posture and the second posture is the portrait posture, it is indicated that the first operation does not conform to the display interface posture of the wearable device 20. The operation information of the first operation in the first axial direction corresponds to the operation information of the wearable device 20 in the second axial direction, and the operation information of the first operation in the second axial direction corresponds to the operation information of the wearable device 20 in the first axial direction. The terminal device change the first operation value of the first operation in the first axial direction to be the second operation value in the second axial direction ensures that the converted second operation conforms to the display interface posture of the wearable device 20.

For example, the operation value of the first operation of the electronic device 10 in the first axial direction (referred to as “first operation value” for ease of description) is denoted as x₁, and the operation value of the first operation in the second axial direction (referred to as “second operation value” for ease of description) is denoted as y₁. The terminal device change the first operation value to be the second operation value represents that the operation value of the second operation of the wearable device 20 in the first axial direction is y₁, and the operation value of the second operation in the second axial direction is x₁, so that the first operation on the electronic device 10 can be correctly output to the display interface of the wearable device 20. According to the embodiments, the influence of posture changes of the electronic device 10 and the wearable device 20 on device control can be avoided by changing the first operation value to be the second operation value, and the device control accuracy of the wearable device 20 can be improved.

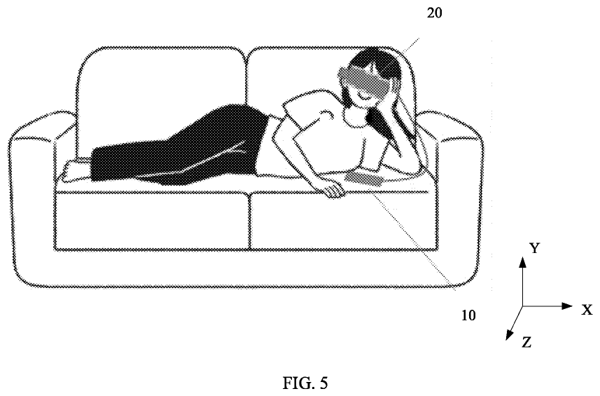

In some embodiments, for example where the first posture is a first tilted posture and the second posture is a second tilted posture, as shown in FIG. 5, a user wears the wearable device 20 and operates the electronic device 10 while lying on a sofa. At this time, the electronic device 10 is in the first tilted posture, and the wearable device 20 is in the second tilted posture. In some embodiments, determining the operation conversion information based on the first posture and the second posture comprises: if the first posture is a first tilted posture and the second posture is a second tilted posture, determining a first tilt angle of the electronic device based on the first tilted posture, and determining a second tilt angle of the wearable device 20 based on the second tilted posture; determining a first operation value of the first operation in a first axial direction and a second operation value of the first operation in a second axial direction; determining the operation conversion information as adjusting the first operation value and the second operation value based on the first tilt angle and the second tilt angle.

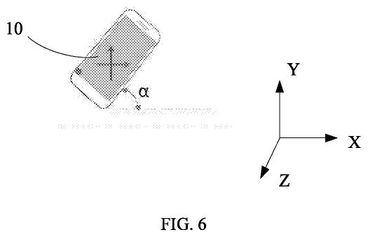

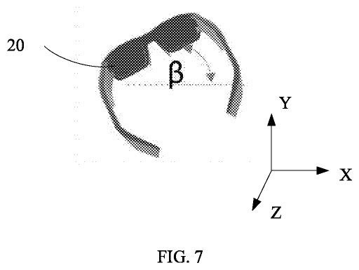

The angle between the line where the long side of the electronic device 10 lies and the first axial direction is recorded as the first tilt angle. The angle between the line where the two lenses of the wearable device 20 lie and the first axial direction is recorded as the second tilt angle. Please refer to FIG. 6 and FIG. 7. FIG. 6 is a schematic diagram of a first tilt angle provided by an embodiment of the present application. FIG. 7 is a schematic diagram of a second tilt angle provided by an embodiment of the present application. The electronic device 10 is in the first tilted posture, and the angle between the electronic device 10 and the first axial direction is recorded as α, i.e., the first tilt angle is α. The wearable device 20 is in the second tilted posture, and the angle between the wearable device 20 and the first axial direction is recorded as β, i.e., the second tilt angle is β. The embodiment of the present application determines the first tilt angle of the electronic device 10 and the second tilt angle of the wearable device 20, and adjusts the first operation based on the first tilt angle and the second tilt angle, thereby avoiding the influence of posture changes of the electronic device 10 and the wearable device 20 on device control, and improving the device control accuracy of the wearable device 20.

In some embodiments, the terminal device adjusts the first operation value and the second operation value based on the first tilt angle and the second tilt angle includes the terminal device determines an angular difference between the first tilt angle and the second tilt angle; adjusts the first operation value using a first trigonometric function based on the angular difference, and adjusts the second operation value using a second trigonometric function based on the angular difference. The first trigonometric function may be a cosine function, and the second trigonometric function may be a sine function. The present embodiments uses trigonometric functions to dynamically adjust the first operation value and the second operation value according to angular changes, adapting to different scenario requirements and improving the accuracy of operation conversion.

Exemplarily, the first operation value is adjusted using Formula 1to obtain the operation value of the second operation corresponding to the first axial direction.

X′n=Xn*cos(β−α) Formula 1:

In Formula 1, X′n represents the operation value of the second operation corresponding to the first axial direction, Xn represents the first operation value, α represents the first tilt angle, and β represents the second tilt angle.

Exemplarily, Formula 2 is used to adjust the second operation value to obtain the operation value of the second operation corresponding to the second axial direction.

Y′h=Yh*sin(β−α) Formula 2:

Here, Y′h represents the operation value of the second operation corresponding to the second axial direction, Yh represents the second operation value, α represents the first tilt angle, and β represents the second tilt angle.

S22, the electronic device convert the first operation into the second operation by using the operation conversion information.

In at least one embodiment of the present application, using the operation conversion information, the first operation on the electronic device 10 can be converted into the second operation for the wearable device 20, so that the wearable device 20 controls display information by executing the second operation.

In the device control method provided by the embodiments of the present application, by identifying the first posture of the electronic device and the second posture of the wearable device, the first operation on the electronic device is converted using the first posture and the second posture to obtain a second operation, and the display information of the wearable device is controlled based on the second operation, thereby avoiding the influence of posture changes of the electronic device and the wearable device on device control, and improving the device control accuracy of the wearable device.

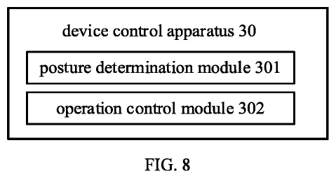

Please refer to FIG. 8. FIG. 8 is a schematic structural diagram of a device control apparatus provided by an embodiment of the present application. In some embodiments, the device control apparatus 30 may include multiple functional modules composed of computer program segments. The computer programs of the various program segments in the device control apparatus 30 can be stored in the memory of the electronic device 10 and executed by at least one processor to perform the functions of device control (as described in detail in FIG. 2).

In some embodiments, the device control apparatus 30 can be divided into multiple functional modules according to the functions it performs. The functional modules may include: an posture determination module 301 and an operation control module 302. The term “module” referred to in this application refers to a series of computer program segments that can be executed by at least one processor and can perform fixed functions, stored in a memory. In this embodiment, the functions of each module will be described in detail in subsequent embodiments.

The posture determination module 301 may be configured to, in response to a first operation by a user, determine a first posture of the electronic device 10 and a second posture of the wearable device 20.

The operation control module 302 may be configured to, if the second posture does not match the first posture, determine a second operation based on the first posture and the second posture, and send a control instruction to the wearable device, so that the wearable device controls display information by executing the second operation, the second operation is different from the first operation.

It can be understood that the device control apparatus 30 and the device control method of the above embodiments belong to the same inventive concept. The specific implementation of each module of the device control apparatus 30 corresponds to the steps of the device control method in the above embodiments, and will not be repeated here.

The module division described above is a logical function division, and there may be other division methods in actual implementation. In addition, the functional modules in the various embodiments of the present application may be integrated into the same processing unit, or each module may exist physically separately, or two or more modules may be integrated into the same unit. The above integrated modules may be implemented in the form of hardware, or in the form of hardware plus software functional modules.

FIG. 9 is a schematic structural diagram of an electronic device provided by an embodiment of the present application. As shown in FIG. 9, the electronic device 10 includes a first display screen 101, a first determination module 102, a communication module 103, a storage device 104, a processor 105, an Input/Output (I/O) interface 106, and a bus 107. The processor 105 is coupled to the communication module 103, the memory 104, and the input/output interface 106 respectively via the bus 107.

In some embodiments, the communication module 103 may include a wired communication module and/or a wireless communication module. The wired communication module may provide one or more of wired communication solutions such as Universal Serial Bus (USB), Controller Area Network (CAN), etc. The wireless communication module may provide one or more of wireless communication solutions such as Wireless Fidelity (Wi-Fi), Bluetooth (BT), mobile communication network, Frequency Modulation (FM), Near Field Communication (NFC), Infrared (IR), etc.

In some embodiments, the memory 104 is used to store one or more computer programs. The one or more computer programs are configured to be executed by the processor 105. The one or more computer programs include a plurality of instructions, and when the plurality of instructions are executed by the processor 105, the device control method executed on the electronic device 10 can be implemented.

In some embodiments, the memory 104 may include one or more Random Access Memories (RAM) and one or more Non-Volatile Memories (NVM). The random access memory can be directly read and written by the processor 105, and can be used to store executable programs (e.g., machine instructions) of the operating system or other running programs, and can also be used to store user and application data, etc. The random access memory may include Static Random-Access Memory (SRAM), Dynamic Random Access Memory (DRAM), Synchronous Dynamic Random Access Memory (SDRAM), Double Data Rate Synchronous Dynamic Random Access Memory (DDR SDRAM), etc.

In some embodiments, the non-volatile memory can also store executable programs and user and application data, etc., and can be loaded into the random access memory in advance for direct reading and writing by the processor 105. The non-volatile memory may include magnetic disk storage devices, flash memory, etc.

In other embodiments, the electronic device 10 also includes an external memory interface for connecting to an external memory to expand the storage capacity of the electronic device 10.

In some embodiments, the processor 105 provides computing and control capabilities, for example, the processor 105 is configured to execute the computer program stored in the memory 104 to implement the above device control method.

In some embodiments, the processor 105 may include one or more processing units, for example, the processor 105 may include an application processor (AP), a modem processor, a graphics processing unit (GPU), an image signal processor (ISP), a controller, a video codec, a digital signal processor (DSP), and/or a neural-network processing unit (NPU), etc. Different processing units may be independent devices or integrated into one or more processors.

In some embodiments, the input/output interface 106 is used to provide a channel for user input or output. For example, the input/output interface 106 can be used to connect various input/output devices, such as a mouse, keyboard, touch device, display screen, etc., so that users can input information or visualize information.

In some embodiments, the bus 107 is at least used to provide a communication channel between the communication module 103, the memory 104, the processor 105, and the input/output interface 106 in the electronic device 10.

It can be understood that the structure illustrated in the embodiment of the present application does not constitute a specific limitation on the electronic device 10. In other embodiments of the present application, the electronic device 10 may include more or fewer components than shown, or combine some components, or separate some components, or arrange components differently. The illustrated components may be implemented in hardware, software, or a combination of software and hardware.

An embodiment of the present application also provides a computer-readable storage medium. The computer-readable storage medium stores a computer program, the computer program includes program instructions, and the method implemented when the program instructions are executed can refer to the methods in the various embodiments above.

The computer-readable storage medium may be the internal memory of the electronic device described in the above embodiments, such as the hard disk or memory of the electronic device. The computer-readable storage medium may also be an external storage device of the electronic device, such as a plug-in hard disk, a Smart Media Card (SMC), a Secure Digital (SD) card, a Flash Card, etc., equipped on the electronic device.

In some embodiments, the computer-readable storage medium may include a program storage area and a data storage area, wherein the program storage area may store an operating system, an application program required for at least one function, etc. ; the data storage area may store data created according to the use of the electronic device, etc.

In the several embodiments provided in this application, it should be understood that the disclosed system, apparatus, and method may be implemented in other ways. For example, the apparatus embodiment described above is merely illustrative. For example, the division of modules is only a logical function division, and there may be other division methods in actual implementation.

The modules described as separate components may or may not be physically separate. The components shown as modules may or may not be physical units, i.e., they may be located in one place or distributed over multiple network units. Some or all of the modules may be selected according to actual needs to achieve the purpose of the solution of this embodiment.

In addition, the functional modules in the various embodiments of the present application may be integrated into one processing unit, or each unit may exist physically separately, or two or more units may be integrated into one unit. The above integrated units may be implemented in the form of hardware or in the form of hardware plus software functional modules.

Therefore, from any point of view, the embodiments should be regarded as exemplary and non-restrictive. The scope of the present application is defined by the appended claims rather than the above description. Therefore, it is intended to include within the present application all changes that fall within the meaning and scope of equivalents of the claims. No associated reference sign in the claims should be construed as limiting the claim involved.

Furthermore, it is clear that the word “comprising” does not exclude other units or steps, and the singular does not exclude the plural. A plurality of units or devices stated in the present application may also be implemented by one unit or device through software or hardware. Terms such as first and second are used to denote names and do not imply any particular order.

Finally, it should be noted that the above embodiments are only used to illustrate the technical solutions of the present application and are not limiting. Although the present application has been described in detail with reference to the preferred embodiments, those of ordinary skill in the art should understand that the technical solutions of the present application may be modified or equivalently substituted without departing from the spirit and scope of the technical solutions of the present application.

What is claimed is:

1. A device control method, applied to an electronic device, which is connected to a wearable device, the device control method comprising:
in response to a first operation of a user, determining a first posture of the electronic device and a second posture of the wearable device;
in response to a determination that the second posture does not match the first posture, determining a second operation based on the first posture and the second posture, and sending a control instruction to the wearable device, wherein the control instruction instructing the wearable device to control display information by executing the second operation, the second operation is different from the first operation.

2. The device control method according to claim 1, wherein determining the first posture of the electronic device and the second posture of the wearable device comprises:
determining at least one of a first angular velocity and a first acceleration of the electronic device along each of a plurality of preset axes; determining the first posture of the electronic device based on the at least one of the first angular velocity and the first acceleration;
determining at least one of a second angular velocity and a second acceleration of the wearable device along each of the plurality of preset axes; determining the second posture of the wearable device based on the at least one of the second angular velocity and the second acceleration.

3. The device control method according to claim 1, further comprising:
in response to a determination that each of the first posture and the second posture is a vertical posture or a determination that each of the first posture and the second posture is a horizontal posture, determining that the second posture matches the first posture, sending a control instruction to the wearable device, wherein the control instruction instructing the wearable device to control the display information by executing the first operation.

4. The device control method according to claim 1, wherein in response to the determination that the second posture does not match the first posture, determining a second operation based on the first posture and the second posture comprises:
determining operation conversion information based on the first posture and the second posture;
converting the first operation into the second operation by using the operation conversion information.

5. The device control method according to claim 4, wherein determining the operation conversion information based on the first posture and the second posture comprises:
in response to a determination that the first posture is a vertical posture and the second posture is a horizontal posture, or a determination that the first posture is the horizontal posture and the second posture is the vertical posture, determining a first operation value of the first operation in a first axial direction and a second operation value of the first operation in a second axial direction;
determining the operation conversion information by changing the first operation value of the first operation in a first axial direction to the second operation value of the first operation in a first axial direction.

6. The device control method according to claim 4, wherein the determining the operation conversion information based on the first posture and the second posture further comprises:
in response to a determination that the first posture is a first tilted posture and the second posture is a second tilted posture, determining a first tilt angle of the electronic device based on the first tilted posture, and determining a second tilt angle of the wearable device based on the second tilted posture;
determining a first operation value of the first operation in a first axial direction and a second operation value of the first operation in a second axial direction;
determining the operation conversion information according to the first tilt angle and the second tilt angle, adjusting the first operation value and the second operation value.

7. The device control method according to claim 6, wherein determining the operation conversion information according to the first tilt angle and the second tilt angle, adjusting the first operation value and the second operation value comprises:
determining an angular difference between the first tilt angle and the second tilt angle;
based on the angular difference, adjusting the first operation value by using a first trigonometric function, and based on the angular difference, adjusting the second operation value by using a second trigonometric function.

8. An electronic device, comprising:
at least one processor;
a storage device, that stores computer programs, which when executed by the at least one processor, cause the at least one processor to:
in response to a first operation of a user, determine a first posture of the electronic device and a second posture of the wearable device;
in response to a determination that the second posture does not match the first posture, determine a second operation based on the first posture and the second posture, and send a control instruction to the wearable device, wherein the control instruction instructing the wearable device to control display information by executing the second operation, the second operation is different from the first operation.

9. The electronic device according to claim 8, the at least one processor is further caused to:
determine at least one of a first angular velocity and a first acceleration of the electronic device along each of a plurality of preset axes; determining the first posture of the electronic device based on the at least one of the first angular velocity and the first acceleration;
determine at least one of a second angular velocity and a second acceleration of the wearable device along each of the plurality of preset axes; determining the second posture of the wearable device based on the at least one of the second angular velocity and the second acceleration.

10. The electronic device according to claim 8, the at least one processor is further caused to:
in response to a determination that each of the first posture and the second posture is a vertical posture or a determination that each of the first posture and the second posture is a horizontal posture, determine that the second posture matches the first posture, sending the control instruction to the wearable device, wherein the control instruction instructing the wearable device to control the display information by executing the first operation.

11. The electronic device according to claim 8, the at least one processor is further caused to:
determine operation conversion information based on the first posture and the second posture;
convert the first operation into the second operation by using the operation conversion information.

12. The electronic device according to claim 11, the at least one processor is further caused to:
in response to a determination that the first posture is a vertical posture and the second posture is a horizontal posture, or a determination that the first posture is the horizontal posture and the second posture is the vertical posture, determine a first operation value of the first operation in a first axial direction and a second operation value of the first operation in a second axial direction;
determine the operation conversion information by changing the first operation value to be the second operation value.

13. The electronic device according to claim 11, the at least one processor is further caused to:
in response to a determination that the first posture is a first tilted posture and the second posture is a second tilted posture, determine a first tilt angle of the electronic device based on the first tilted posture, and determine a second tilt angle of the wearable device based on the second tilted posture;
determine a first operation value of the first operation in a first axial direction and a second operation value of the first operation in a second axial direction;
determine the operation conversion information according to the first tilt angle and the second tilt angle, adjusting the first operation value and the second operation value.

14. The electronic device according to claim 13, the at least one processor is further caused to:
determine an angular difference between the first tilt angle and the second tilt angle;
based on the angular difference, adjust the first operation value by using a first trigonometric function, and based on the angular difference, adjust the second operation value by using a second trigonometric function.

15. A non-transitory storage medium, having stored thereon at least one computer-readable instructions, which when executed by a processor of an electronic device, causes the processor to perform a device control method, the device control method comprising:
in response to a first operation of a user, determining a first posture of the electronic device and a second posture of the wearable device;
in response to a determination that the second posture does not match the first posture, determining a second operation based on the first posture and the second posture, and sending a control instruction to the wearable device, wherein the control instruction instructing the wearable device to control display information by executing the second operation, the second operation is different from the first operation.

16. The non-transitory storage medium according to claim 15, wherein determining the first posture of the electronic device and the second posture of the wearable device comprises:
determining at least one of a first angular velocity and a first acceleration of the electronic device along each of a plurality of preset axes; determining the first posture of the electronic device based on the at least one of the first angular velocity and the first acceleration;
determining at least one of a second angular velocity and a second acceleration of the wearable device along each of the plurality of preset axes; determining the second posture of the wearable device based on the at least one of the second angular velocity and the second acceleration.

17. The non-transitory storage medium according to claim 15, wherein the method further comprises:
in response to a determination that each of the first posture and the second posture is a vertical posture or a determination that each of the first posture and the second posture is a horizontal posture, determining that the second posture matches the first posture, sending the control instruction to the wearable device, wherein the control instruction instructing the wearable device to control the display information by executing the first operation.

18. The non-transitory storage medium according to claim 15, wherein determining a second operation based on the first posture and the second posture comprises:
determining operation conversion information based on the first posture and the second posture;
converting the first operation into the second operation by using the operation conversion information.

19. The non-transitory storage medium according to claim 18, wherein determining operation conversion information based on the first posture and the second posture comprises:
in response to a determination that the first posture is a vertical posture and the second posture is a horizontal posture, or a determination that the first posture is the horizontal posture and the second posture is the vertical posture, determining a first operation value of the first operation in a first axial direction and a second operation value of the first operation in a second axial direction;
determining the operation conversion information by changing the first operation value of the first operation in a first axial direction to the second operation value of the first operation in a first axial direction.

20. The non-transitory storage medium according to claim 18, wherein the determining operation conversion information based on the first posture and the second posture further comprises:
in response to a determination that the first posture is a first tilted posture and the second posture is a second tilted posture, determining a first tilt angle of the electronic device based on the first tilted posture, and determining a second tilt angle of the wearable device based on the second tilted posture;
determining a first operation value of the first operation in a first axial direction and a second operation value of the first operation in a second axial direction;
determining the operation conversion information according to the first tilt angle and the second tilt angle, adjusting the first operation value and the second operation value.
